(19) United States
(12) Patent Application Publication
(10) Pub. No.: US 2022/0212259 A1
(43) Pub. Date: Jul. 7, 2022

(54) Apparatus and Method for Producing an Object by Means of Additive Manufacturing

(71) Applicant: Additive Industries B.V., Eindhoven (NL)

(72) Inventors: Erwin Wijn, Eindhoven (NL); Mark Herman Else Vaes, Eindhoven (NL)

(21) Appl. No.: 17/604,939

(22) PCT Filed: Jun. 12, 2020
(86) PCT No.: PCT/NL2020/050379

§ 371 Date: Oct. 19, 2021

(30) Foreign Application Priority Data
Jun. 18, 2019 (NL) 2023337

(51) Int. Cl. B22F 10/36; B22F 12/47; B22F 10/28; B22F 12/30; B33Y 30/00; B33Y 10/00

(52) U.S. Cl. CPC B22F 10/36; B22F 12/47; B33Y 10/00; B22F 12/30; B33Y 30/00; B22F 10/28

(57) ABSTRACT

An apparatus for producing an object by additive manufacturing including a process chamber for receiving a bath of powdered material, a support for positioning the object relative to a surface level of the bath of powdered material, a solidifying device for emitting a beam of electromagnetic radiation to solidify a selective part of a layer of the powdered material, and a control device for controlling an energy density of the electromagnetic radiation, during solidification of the selective part of the layer, according to a position of the beam of electromagnetic radiation at the surface level. A method for producing an objective by additive manufacturing.

According to a first aspect the present disclosure relates to an apparatus for manufacturing an object by means of additive manufacturing.

The present disclosure relates according to a second aspect to a method for producing an object by means of additive manufacturing using an apparatus.

3D printing or additive manufacturing refers to any of various processes for manufacturing a three-dimensional object in which material is joined or solidified under computer control to create a three-dimensional object, with material being added together, typically layer by layer.

A known apparatus for printing a three-dimensional object comprises:

a process chamber for receiving a bath of powdered material which can be solidified by exposure to electromagnetic radiation;

a support for positioning a part of said object in relation to a surface level of said bath of powdered material;

a solidifying device arranged for emitting a beam of electromagnetic radiation on said surface level for solidifying a selective part of a layer of powdered material of said bath of powdered material.

One of the challenges is how to realize an object using an apparatus for printing three-dimensional objects having a relative high product quality.

It is an object of the present disclosure to provide an apparatus and a method for producing an object, by additive manufacturing, that allows to manufacture objects having a relative high product quality.

This objective is achieved by the apparatus according to the first aspect of the present disclosure for producing an object by means of additive manufacturing, said apparatus comprising:

a process chamber for receiving a bath of powdered material which can be solidified by exposure to electromagnetic radiation;

a support for positioning a part of said object in relation to a surface level of said bath of powdered material;

a solidifying device arranged for emitting a beam of electromagnetic radiation on said surface level for solidifying a selective part of a layer of said powdered material of said bath of powdered material; and

a control device arranged for controlling an energy density of said electromagnetic radiation, during solidification of said selective part of said layer of said powdered material of said bath of powdered material, taking into account a position of said beam of electromagnetic radiation at said surface level.

By providing the control device a relative high product quality may be realized. Controlling the energy density allows to realize a manufacturing process that is relative stable as regards solidification of the powdered material. The present disclosure relies at least partly on the insight that a relative large variation of energy density during manufacturing of an object may result in a relative low product quality. The relative low product quality may be due to variations of the solidification process of the powdered material for manufacturing the object. A relative low energy density may for instance result in inclusions of powdered material in the object. Alternatively a relative high energy density may result in evaporation and/or ablation of powdered material thereby affecting the quality of the object. Moreover, relative small variations of energy density may result in variations of mechanical characteristics of the solidified powdered material due to temperature differences during the solidification and the subsequent cooling of the powdered material.

The present disclosure relies further at least partly on the insight that characteristics of the beam of electromagnetic radiation may be different for different positions at said surface level. The control device comprised by the apparatus according to the present is arranged for taking into account the position of the beam of electromagnetic radiation at the surface level for controlling the energy density of the electromagnetic radiation. A dimension of the beam of electromagnetic radiation, being a characteristic of the beam of electromagnetic radiation, may vary along the surface level for instance due to the optics provided between the solidifying device and the surface level for shaping and displacing said beam of electromagnetic radiation along said surface level.

In particular, when using a scanning mirror device for deflecting the beam of electromagnetic radiation along the surface level, a dimension of the beam of electromagnetic radiation may vary due to a change of an angle of incidence of the beam of electromagnetic radiation on the surface level due to movement of said beam of electromagnetic radiation along the surface level.

Moreover, by changing the position of the beam of electromagnetic radiation along the surface level, the optical path of the beam of electromagnetic radiation may differ thereby resulting in a difference between a focal plane of the beam of electromagnetic radiation and the surface level. A correction of a difference between the focal plane of the beam of electromagnetic radiation and the surface level may contribute to a variation of a dimension of the beam of electromagnetic radiation.

A further advantage of the apparatus according to the first aspect is that by providing the control device a feed-forward compensation may be realized for controlling the energy density of the electromagnetic radiation, during solidification of said selective part of said powdered material, taking into account a position of said beam of electromagnetic radiation at said surface level.

The control device may comprise a lookup table provided with settings related to a position of said beam of electromagnetic radiation along said surface level for controlling said energy density of said beam of electromagnetic radiation along said surface level.

In this regard, it is advantageous if said control device is arranged for controlling said energy density of said electromagnetic radiation at said surface level taking into account said position of said beam of electromagnetic radiation at said surface level.

Within the context of the present disclosure, the energy density may be defined in terms of the power of the beam of electromagnetic radiation, a surface area or diameter of the beam of electromagnetic radiation at the surface level, a movement speed of the beam of electromagnetic radiation at the surface level and a hatch distance of the beam of electromagnetic radiation at the surface level, wherein the hatch distance is a distance between neighbouring scan lines of the beam of electromagnetic radiation at the surface level. The energy density is expressed in terms of Joule/cm².

Controlling the energy density of the electromagnetic radiation at the surface level is beneficial for realizing a relative large power input of electromagnetic radiation in said powdered material while realizing a relative high product quality. It is noted that a relative high energy density at the surface level may result in evaporation and/or ablation of powdered material at the surface level, whereas a relative low energy density may result in a relative slow manufacturing process or may result in inclusions of powdered material in the object.

Preferably, the energy density of the electromagnetic radiation at the surface level is maintained within a predetermined range. The predetermined range takes into account the material characteristic such as for instance particle size and/or the type of metal of the powdered material. This is beneficial for realizing a relative high product quality while allowing a relative short time for manufacturing the object.

It is advantageous if said control device is arranged for controlling said energy density of said beam of electromagnetic radiation at said surface level by controlling a dimension of said beam of electromagnetic radiation at said surface level and/or a power of said beam of electromagnetic radiation at said surface level. Controlling a dimension of said beam of electromagnetic material may involve changing a dimension of said beam of electromagnetic radiation.

Preferably, said control device is arranged for controlling an energy density of said electromagnetic radiation at said surface level, by controlling a dimension of said beam of electromagnetic radiation at said surface level, during solidification of said selective part of said layer of said powdered material of said bath of powdered material, taking into account a position of said beam of electromagnetic radiation at said surface level such that at a constant power of said beam of electromagnetic radiation said energy density of said electromagnetic radiation at said surface level (L) is maintained substantially constant, preferably constant, more preferably within a range of 10%, 5%, 3% or 1%, along said surface level. This is beneficial for realizing a relative high product quality.

Preferably, said control device is arranged for maintaining said energy density at said surface level along said surface level within a range of 10% of a nominal energy density at said surface level.

Within the context of the present disclosure a nominal energy density may be understood as a predetermined set energy density. A nominal energy density at said surface level is therefore to be understood as a predetermined set energy density at said surface level.

Preferably, said control device is arranged for maintaining said energy density at said surface level along said surface level within a range of 5% of a nominal energy density at said surface level.

Preferably, said control device is arranged for maintaining said energy density at said surface level along said surface level within a range of 3% of a nominal energy density at said surface level.

Preferably, said control device is arranged for maintaining said energy density at said surface level along said surface level within a range of 1% of a nominal energy density at said surface level.

It is beneficial if said control device is arranged for maintaining said energy density at said surface level constant along said surface level.

It is advantageous if said control device is arranged for controlling said energy density of said electromagnetic radiation in a volume of said bath of powdered material taking into account said position of said beam of electromagnetic radiation at said surface level, preferably wherein said energy density at any position in said volume is larger than zero.

Preferably, said control device is arranged for controlling said energy density of said electromagnetic radiation in a volume of said bath of powdered material, by controlling said dimension of said beam of electromagnetic radiation, taking into account said position of said beam of electromagnetic radiation at said surface level such that at said constant output power of said beam of electromagnetic radiation said energy density in said volume of said bath of powdered material of said electromagnetic radiation is maintained substantially constant, preferably constant, more preferably within a range of 10%, 5%, 3% or 1%, along said surface level, wherein said energy density at any position in said volume is larger than zero. This is beneficial for realizing a relative high product quality.

The energy density of the electromagnetic radiation in a volume of said bath of powdered material may also be referred to as volumetric energy density. The volumetric energy density may be defined in terms of the power of the beam of electromagnetic radiation, a layer thickness of said powdered material, a movement speed of said beam of electromagnetic radiation along the surface level and a hatch distance of the beam of electromagnetic radiation at the surface level, wherein the hatch distance is a distance between neighbouring scan lines of the beam of electromagnetic radiation at the surface level. The volumetric energy density is expressed in terms of Joule/cm³.

It is noted that due to absorption of the electromagnetic radiation, by the powdered material, and/or the caustic of the beam of electromagnetic radiation the volumetric energy density may vary in said volume of said bath of powdered material. In this regard, the volumetric energy density may be defined as an average energy density of said electromagnetic radiation in the volume of the bath of material, wherein said energy density in any position of said volume is larger than zero.

Within the context of the present disclosure, said volume of said bath of powdered material is to be understood as a part of said bath of powdered material wherein said energy density is larger than zero.

Preferably, the average energy density of the electromagnetic radiation in the volume of the bath of material is maintained within a predetermined range. The predetermined range takes into account the material characteristic such as for instance particle size and/or the type of metal of the powdered material. This is beneficial for realizing a relative high product quality while allowing a relative short time for manufacturing the object.

In this regard, it is beneficial if said control device is arranged for controlling said energy density of said beam of electromagnetic radiation in said volume of said bath of powdered material by controlling at least one of:

a dimension of said beam of electromagnetic radiation at said surface level;

a power of said beam of electromagnetic radiation at said surface level;

a thickness of said layer of said powdered material of said bath of powdered material; and

a speed of moving said beam of electromagnetic radiation along said surface level.

In an embodiment of the apparatus according to the first aspect of the present disclosure, said control device is arranged for changing said dimension of said beam of electromagnetic radiation at said surface level by controlling at least one of:

a focus setting of said beam of electromagnetic radiation;

a beam shape of said beam of electromagnetic radiation;

an expansion of said beam of electromagnetic radiation.

Preferably, said control device is arranged for controlling said power of said beam of electromagnetic radiation at said surface level by controlling at least one of:

a duty cycle of said solidifying device;

an output power of said solidifying device.

It is advantageous if said control device is further arranged for controlling a hatch distance at said surface level of said beam of electromagnetic radiation taking into account said dimension of said beam of electromagnetic radiation.

Preferably, the control device is communicatively coupled to said solidifying device.

Preferably, the apparatus according to the first aspect of the present disclosure comprises a beam shaping device for changing a focus setting and/or a beam shape of said beam of electromagnetic radiation, wherein said control device is communicatively coupled to said beam device for changing, by said control device, said focus setting and/or said beam shape of said beam of electromagnetic radiation.

In a practical embodiment of the apparatus according to the first aspect the control device is arranged for controlling said energy density of said electromagnetic radiation at said surface level taking into account said position of said beam of electromagnetic radiation at said surface level and for controlling said energy density of said electromagnetic radiation in said volume of said bath of powdered material taking into account said position of said beam of electromagnetic radiation at said surface level, wherein said energy density at any position in said volume is larger than zero.

Controlling both the energy density at said surface level and the volumetric energy density allows for realizing a relative large energy input in the layer of powdered material while realizing a relative high product quality. The present disclosure relies at least partly on the insight that both the energy density at said surface level and the volumetric energy density may be controlled separately, preferably by a single control device, and are preferably both controlled within a predetermined range.

According to the second aspect, the present disclosure relates to a method for producing an object by means of additive manufacturing, wherein said method comprises the steps of:

receiving, in a process chamber, a bath of powdered material, wherein a surface level of said bath of powdered material defines an object working area;

solidifying, by a solidifying device arranged for providing a beam of electromagnetic radiation, a selective part of a layer of said powdered material of said bath of powdered material by means of said beam of electromagnetic radiation;

controlling, by a control device, during said step of solidifying, an energy density of said beam of electromagnetic radiation, taking into account a position of said beam of electromagnetic radiation at said surface level.

Embodiments of the method according to the second aspect correspond to embodiments of the apparatus according to the first aspect of the present disclosure. The advantages of the method according to the second aspect correspond to advantages of the apparatus according to first aspect of the present disclosure presented previously.

Preferably, during said step of controlling, by said control device, said energy density of said beam of electromagnetic radiation at said surface level is controlled by controlling a dimension of said beam of electromagnetic radiation at said surface level, taking into account a position of said beam of electromagnetic radiation at said surface level such that at a constant output power of said beam of electromagnetic radiation said energy density of said electromagnetic radiation at said surface level is maintained substantially constant, preferably constant, more preferably within a range of 10%, 5%, 3% or 1%, along said surface level. This is beneficial for realizing a relative high product quality.

It is advantageous if said control device is arranged for controlling said energy density of said electromagnetic radiation at said surface level taking into account said position of said beam of electromagnetic radiation at said surface level and wherein during said step of controlling, said control device is controlling said energy density of said electromagnetic radiation at said surface level taking into account said position of said beam of electromagnetic radiation at said surface level.

In this regard, it is beneficial if said control device is arranged for controlling said energy density of said beam of electromagnetic radiation at said surface level by changing a dimension of said beam of electromagnetic radiation at said surface level and/or a power of said beam of electromagnetic radiation at said surface level and wherein during said step of controlling, said control device changes at least one of said dimension of said beam of electromagnetic radiation at said surface level and said power of said beam of electromagnetic radiation at said surface.

Preferably, said control device is arranged for maintaining said energy density at said surface level constant along said surface level and wherein, during said step of controlling, said control device maintains said energy density at said surface level constant along said surface level.

Preferably, said control device is arranged for maintaining said energy density at said surface level along said surface level within a range of 10% of a nominal energy density at said surface level and wherein, during said step of controlling, said control device maintains said energy density at said surface level along said surface level within a range of 10% of a nominal energy density at said surface level.

Preferably, said control device is arranged for maintaining said energy density at said surface level along said surface level within a range of 5% of a nominal energy density at said surface level and wherein, during said step of controlling, said control device maintains said energy density at said surface level along said surface level within a range of 5% of a nominal energy density at said surface level.

Preferably, said control device is arranged for maintaining said energy density at said surface level along said surface level within a range of 3% of a nominal energy density at said surface level and wherein, during said step of controlling, said control device maintains said energy density at said surface level along said surface level within a range of 3% of a nominal energy density at said surface level.

Preferably, said control device is arranged for maintaining said energy density at said surface level along said surface level within a range of 1% of a nominal energy density at said surface level and wherein, during said step of controlling, said control device maintains said energy density at said surface level along said surface level within a range of 1% of a nominal energy density at said surface level.

Preferably, said control device is arranged for controlling said energy density of said electromagnetic radiation in a volume of said bath of powdered material taking into account said position of said beam of electromagnetic radiation at said surface level, wherein said energy density at any position in said volume is larger than zero and wherein during said step of controlling said control device is controlling said energy density of said electromagnetic radiation in said volume of said bath of powdered material taking into account said position of said beam of electromagnetic radiation at said surface level.

Preferably, said control device is arranged for controlling said energy density of said electromagnetic radiation in a volume of said bath of powdered material, by controlling said dimension of said beam of electromagnetic radiation, taking into account said position of said beam of electromagnetic radiation at said surface level such that at said constant output power of said beam of electromagnetic radiation said energy density in said volume of said bath of powdered material of said electromagnetic radiation is maintained substantially constant along said surface level, wherein said energy density at any position in said volume is larger than zero, and wherein during said step of controlling said control device is controlling said energy density of said electromagnetic radiation in said volume of said bath of powdered material, by controlling said dimension of said beam of electromagnetic radiation, taking into account said position of said beam of electromagnetic radiation at said surface level such that at said constant output power of said beam of electromagnetic radiation said energy density in said volume of said bath of powdered material of said electromagnetic radiation is maintained substantially constant, preferably constant, more preferably within a range of 10%, 5%, 3% or 1%, along said surface level. This is beneficial for realizing a relative high product quality.

In this regard, it is beneficial if said control device is arranged for controlling said energy density of said beam of electromagnetic radiation in said volume of said bath of powdered material by controlling at least one of:

a dimension of said beam of electromagnetic radiation at said surface level;

a power of said beam of electromagnetic radiation at said surface level;

a thickness of said layer of said powdered material; and

a speed of moving said beam of electromagnetic radiation along said surface level;

and wherein during said step of controlling, said control device is controlling said energy density of said beam of electromagnetic radiation in said volume of said bath of powdered material by controlling at least one of:

said dimension of said beam of electromagnetic radiation at said surface level;

said power of said beam of electromagnetic radiation at said surface level;

said thickness of said layer of said powdered material of said bath of powdered material; and

said speed of moving said beam of electromagnetic radiation along said surface level

Preferably, said control device is arranged for controlling said dimension of said beam of electromagnetic radiation at said surface level by controlling at least one of:

a focus setting of said beam of electromagnetic radiation;

a beam shape of said beam of electromagnetic radiation;

an expansion of said beam of electromagnetic radiation; and

wherein during said step of controlling said control device controls said dimension of said beam of electromagnetic radiation at said surface level by controlling at least one of:

said focus setting of said beam of electromagnetic radiation;

said beam shape of said beam of electromagnetic radiation;

said expansion of said beam of electromagnetic radiation.

Preferably, said control device is arranged for controlling said power of said beam of electromagnetic radiation at said surface level by controlling at least one of:

a duty cycle of said solidifying device;

an output power of said solidifying device; and

wherein during said step of controlling said control device changes said power of said beam of electromagnetic radiation at said surface level by controlling at least one of:

said duty cycle of said solidifying device;

said output power of said solidifying device.

Preferably, said control device is further arranged for controlling a hatch distance at said surface level of said beam of electromagnetic radiation taking into account said dimension of said beam of electromagnetic radiation and wherein said control device controls said hatch distance at said surface level of said beam of electromagnetic radiation taking into account said dimension of said beam of electromagnetic radiation.

The apparatus and method according to the present disclosure will next be explained by means of the accompanying schematic figures. In the figures:

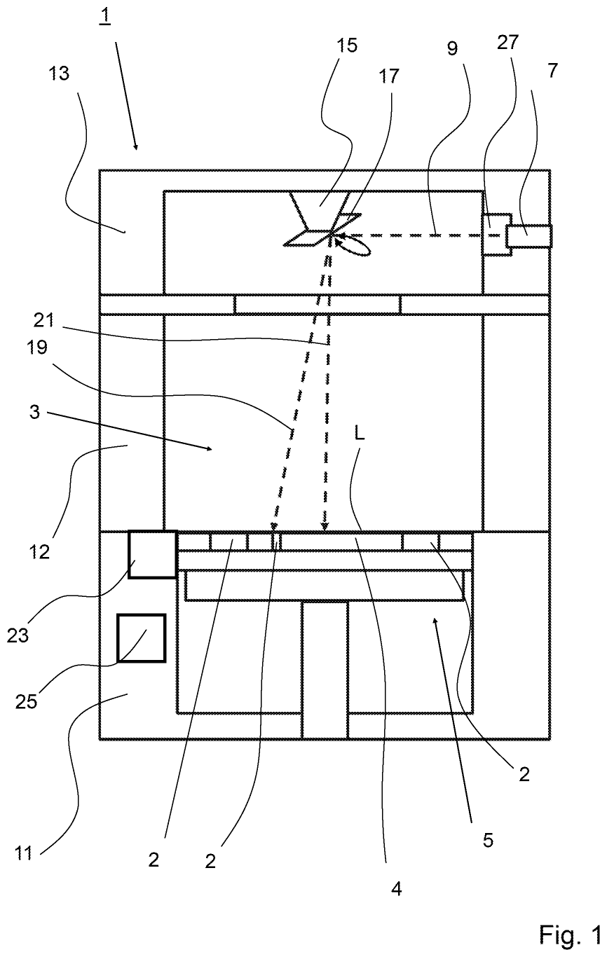

FIG. 1: shows a schematic overview of an apparatus according to the second aspect of the present disclosure;

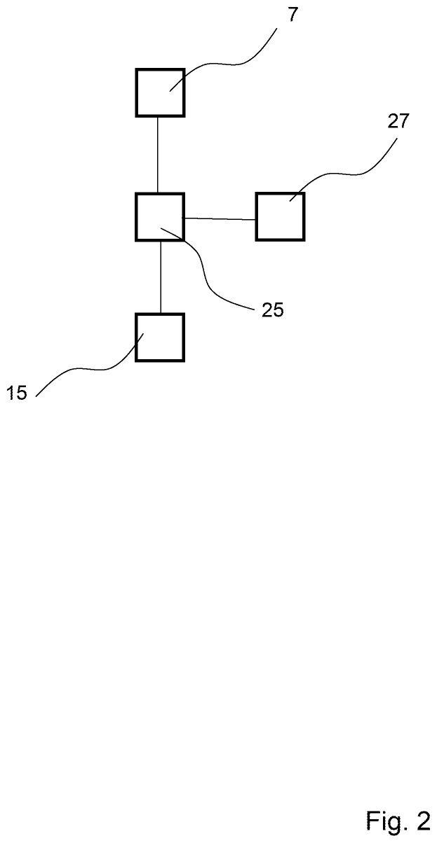

FIG. 2: shows elements of the apparatus from FIG. 1;

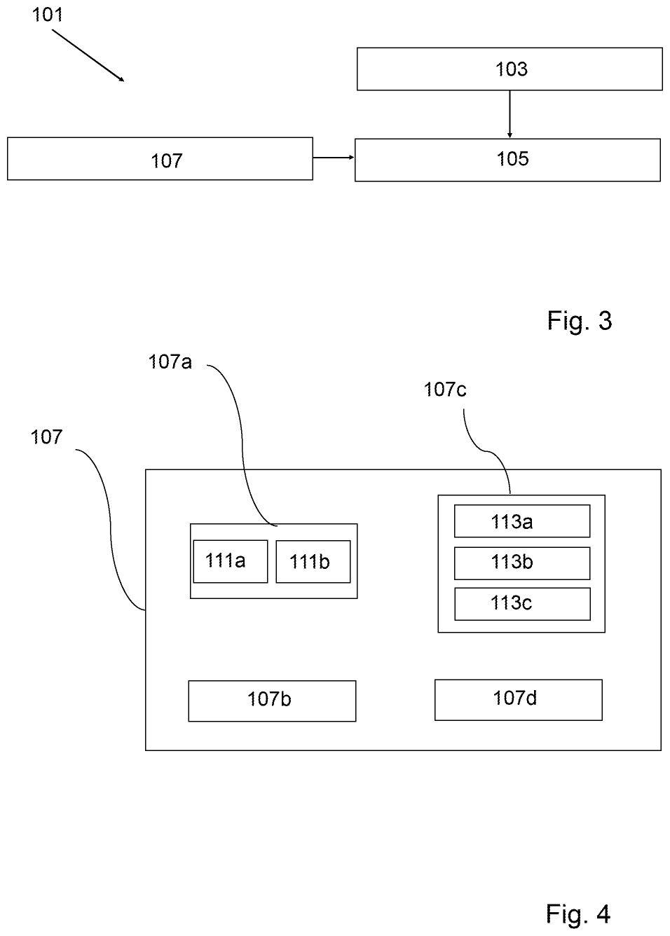

FIG. 3: shows a schematic overview of a method according to the second aspect of the present disclosure;

FIG. 4: shows elements of the method according to FIG. 3;

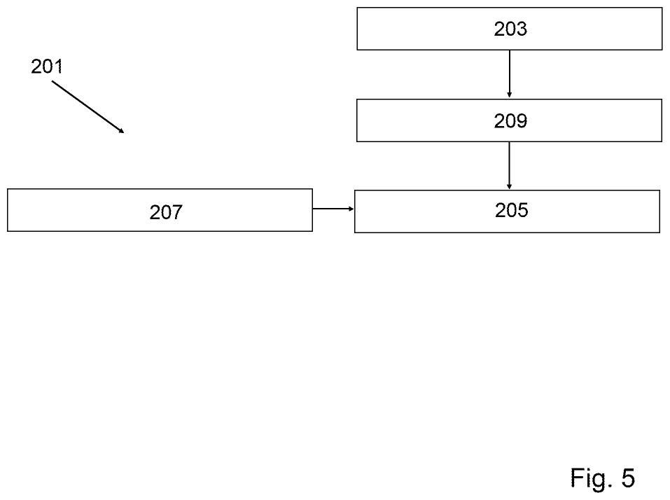

FIG. 5: shows a schematic overview of a further method according to the second aspect of the present disclosure;

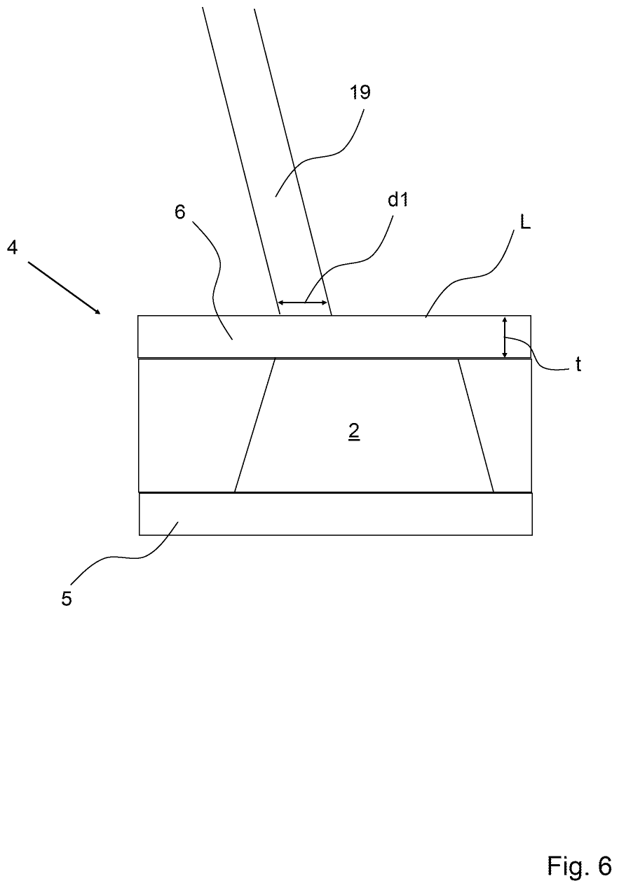

FIG. 6: shows a side view of a bath of powdered material in an apparatus according to the first aspect of the present disclosure;

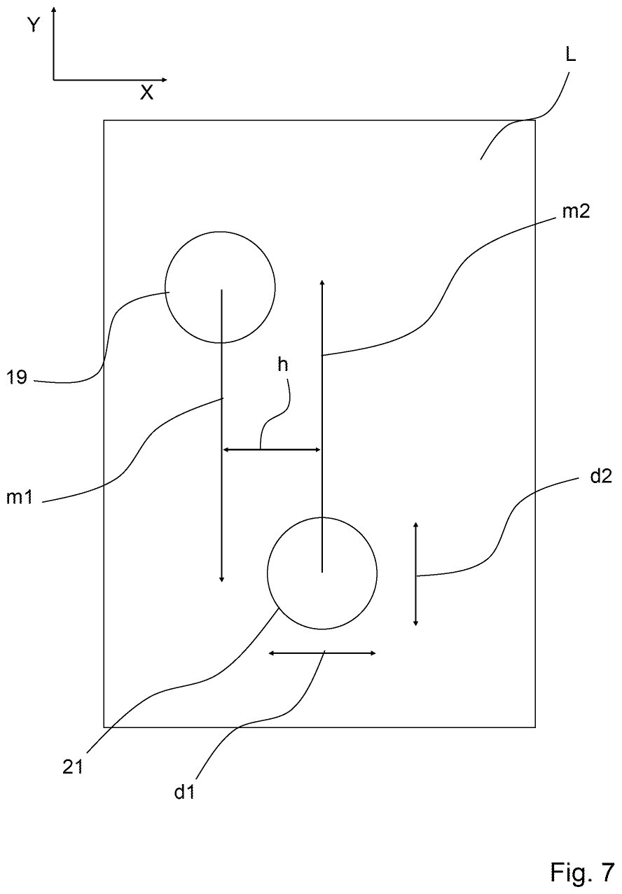

FIG. 7: shows a top view of the bath of powdered material from FIG. 6.

FIG. 1 shows an overview of an apparatus 1 for producing an object 2 by means of additive manufacturing. The apparatus 1 is built from several frame parts 11, 12, 13. The apparatus comprises a process chamber 3 for receiving a bath of material 4 which can be solidified. The material of said bath of material 4 is provided from a supply container 23. In a lower frame part 11, a shaft is formed, wherein a support 5 is provided for positioning the object 2 (or even objects) in relation to the surface level L of the bath of material 4. The support 5 is movably provided in the shaft, such that after solidifying a part of a layer 6, the support 5 may be lowered, and a further layer of material may be applied and at least partly solidified on top of the part of the object 2 already formed. In a top part 13 of the apparatus 1, a solidifying device 7 is provided for solidifying a selective part of the material 4.

In the embodiment shown, the solidifying device 7 is a laser device, which is arranged for producing electromagnetic radiation in the form of laser light, in order to melt powdered material 4 provided on the support 5, which then, after cooling, forms a solidified part of the object 2 to be produced. However, the invention is not limited to the type of solidifying device. As can be seen, the electromagnetic radiation 9 emitted by the laser device 7 is deflected by means of a displacement unit comprising a deflector unit 15, which uses a rotatable optical element 17 to direct the emitted radiation 9 towards the surface L of the layer of material 4. Depending on the position of the deflector unit 15, radiation may be emitted, as an example, according to rays 19, 21.

Apparatus 1 further comprises a control device 25. Control device 25 is arranged for controlling an energy density of said electromagnetic radiation at said surface level L, during solidification of said selective part of said layer 6 of said powdered material of said bath of powdered material 4, taking into account a position of said beam of electromagnetic radiation 19, 21 at said surface level L. The control device 25 is communicatively coupled to the solidifying device 7 and the deflector unit 15. The control device 25 may control the energy density at said surface level L by changing a duty cycle of the solidifying device 7 and/or by changing an output power of the solidifying device 7. Communicatively coupling the control device 25 to the deflector unit 15 allows for controlling the energy density by changing a speed of moving said beam of electromagnetic radiation 19, 21 along said surface level L and/or controlling the energy density by changing a hatch distance h at said surface level L of said beam of electromagnetic radiation 19, 21 taking into account a dimension d1, d2 of the beam of electromagnetic radiation 19, 21 at the surface level L. Dimension d1 corresponds to the size of the beam of electromagnetic radiation at the surface level L in a first direction X, and d2 correspond to the size of the beam of electromagnetic radiation at the surface level L in a second direction Y. The first direction X and the second direction Y are mutually perpendicular and directed parallel to the surface level L. During manufacturing of the object 2, the beam of electromagnetic radiation is moved along the surface level L for solidifying the part of the layer 6 for forming a layer part of object 2. Solidification of the part of layer 6 that forms a layer part of object 2 may be done by repeatedly moving said beam in direction m1 and subsequently in direction m2, wherein said beam is displaced in a direction perpendicular to m1 and/or m2 by the hatch distance h.

In addition, the control device 25 is communicatively coupled to beam shaping optics 27 for changing a focus setting and/or a dimension d1, d2 of the beam of electromagnetic radiation 19, 21 at the surface level L such that at a constant power of said beam of electromagnetic radiation said energy density of said electromagnetic radiation at said surface level L is maintained substantially constant, preferably constant, along said surface level L. The control device 25 is further arranged for moving the support 5 and thereby controlling a thickness t of the layer 6 of the powdered material of the bath of powdered material 4.

The control device 25 is arranged for controlling said energy density of said electromagnetic radiation at said surface level L taking into account said position of said beam of electromagnetic radiation 19, 21 at said surface level L while simultaneously controlling said energy density of said electromagnetic radiation in a volume of said bath of powdered material 4. The control device 25 takes into account said position of said beam of electromagnetic radiation 19, 21 at said surface level L for maintaining said energy density at said surface level L along said surface level within a range of 10%, preferably within a range of 3% of a nominal energy density at said surface level and/or for maintaining the energy density of said electromagnetic radiation in the volume of the bath of powdered material 4 within a range of 10%, preferably within a range of 3% of a nominal energy density in said volume of said bath of material.

Method 101 comprises a step 103 of receiving, in the process chamber 3, a bath of powdered material 4, wherein a surface level L of the bath of powdered material 4 defines an object working area. A subsequent step 105 of method 101 is solidifying, by solidifying device 7, a selective part of said layer 6 of said bath of powdered material 4 on said surface level L. A step 107 of controlling, by the control device 25, is performed during said step 105 of solidifying. During step 107 of controlling, the energy density of the beam of electromagnetic radiation 19, 21 is controlled taking into account a position of the beam of electromagnetic radiation 19, 21 at said surface level L. The step 107 of controlling during the step 105 of solidifying may comprise controlling 107a the power of the beam of electromagnetic radiation 19, 21 at said surface level L, controlling 107b a speed of moving the beam of electromagnetic radiation 19, 21 along the surface level L, controlling 107c a dimension d1, d2 of the beam of electromagnetic radiation 19, 21 at the surface level L and/or controlling 107d the hatch distance h at said surface level L of said beam of electromagnetic radiation 19, 21 for maintaining said energy density at said surface level L along said surface level within a range of 10%, preferably within a range of 3% of a nominal energy density at said surface level and/or for maintaining the energy density of said electromagnetic radiation in the volume of the bath of powdered material 4 within a range of 10%, preferably within a range of 3% of a nominal energy density in said volume of said bath of material.

The step of controlling 107a the power of the beam of electromagnetic radiation may comprises a sub-step 111a of controlling a duty cycle of said solidifying device 7 and/or a sub-step 111b of controlling an output power of said solidifying device 7. The step of controlling 107 a dimension d1, d2 of the beam of electromagnetic radiation may comprise a sub-step 113a of controlling a focus setting of said beam of electromagnetic radiation, a sub-step 113b of controlling a beam shape of said beam of electromagnetic radiation and/or a sub-step 113c of controlling expansion of said beam of electromagnetic radiation. During said step 105 of solidifying, said beam of electromagnetic radiation may be moved along said surface level L as is shown in FIG. 5.

Method 201 differs mainly from method 101 in that said method further comprises the step 209 of applying a layer of said powdered material 4, wherein a thickness of said layer is controlled by said controlling device 25. Steps of method 201 that are similar to steps of method 101 are provided with a reference number equal to the reference number of the step in method 101 raised by 100.

1-16. (canceled)

17. An apparatus for producing an object by additive manufacturing, comprising:
a process chamber configured to receive a bath of powdered material configured to be solidified by exposure to electromagnetic radiation;
a support configured to position a part of the object relative to a surface level of the bath of powdered material;
a solidifying device configured to emit a beam of electromagnetic radiation on the surface level to solidify a selective part of a layer of the powdered material of the bath of powdered material; and
a control device configured to control an energy density of the electromagnetic radiation at the surface level, by controlling a dimension of the beam of electromagnetic radiation at the surface level, during solidification of the selective part of the layer of the powdered material of the bath of powdered material, according to a position of the beam of electromagnetic radiation at the surface level such that at a constant power of the beam of electromagnetic radiation the energy density of the electromagnetic radiation at the surface level is maintained substantially constant along the surface level.

18. The apparatus according to claim 17, wherein the control device is configured to control the energy density of the beam of electromagnetic radiation at the surface level by controlling a power of the beam of electromagnetic radiation at the surface level.

19. The apparatus according to claim 18, wherein the control device is configured to maintain the energy density at the surface level along the surface level within a range of 3% of a nominal energy density at the surface level.

20. The apparatus according to claim 18, wherein the control device is configured to maintain the energy density at the surface level constant along the surface level.

21. The apparatus according to claim 17, wherein the control device is configured to control the energy density of the electromagnetic radiation in a volume of the bath of powdered material, by controlling the dimension of the beam of electromagnetic radiation, according to the position of the beam of electromagnetic radiation at the surface level such that at the constant output power of the beam of electromagnetic radiation the energy density in the volume of the bath of powdered material of the electromagnetic radiation is maintained substantially constant along the surface level, wherein the energy density at any position in the volume is larger than zero.

22. The apparatus according to claim 21, wherein the control device is configured to control the energy density of the beam of electromagnetic radiation in the volume of the bath of powdered material by controlling at least one of:
a thickness of the layer of the powdered material of the bath of powdered material; and
a speed of moving the beam of electromagnetic radiation along the surface level.

23. The apparatus according to claim 17, wherein the control device is configured to control the dimension of the beam of electromagnetic radiation at the surface level by controlling at least one of:
a focus setting of the beam of electromagnetic radiation;
a beam shape of the beam of electromagnetic radiation; and
an expansion of the beam of electromagnetic radiation.

24. The apparatus according to claim 18, wherein the control device is configured to control the power of the beam of electromagnetic radiation at the surface level by controlling at least one of:
a duty cycle of the solidifying device; and
an output power of the solidifying device.

25. The apparatus according to claim 17, wherein the control device is configured to control a hatch distance at the surface level of the beam of electromagnetic radiation according to the dimension of the beam of electromagnetic radiation.

26. A method for producing an object by additive manufacturing, comprising the steps of:
receiving, in a process chamber, a bath of powdered material, wherein a surface level of the bath of powdered material defines an object working area;
solidifying, by a solidifying device configured to provide a beam of electromagnetic radiation, a selective part of a layer of powdered material of the bath of powdered material by the beam of electromagnetic radiation; and
controlling, by a control device, during the step of solidifying, an energy density of the beam of electromagnetic radiation at the surface level, by controlling a dimension of the beam of electromagnetic radiation at the surface level, according to a position of the beam of electromagnetic radiation at the surface level such that at a constant output power of the beam of electromagnetic radiation the energy density of the electromagnetic radiation at the surface level is maintained substantially constant along the surface level.

27. The method according to claim 26, wherein the control device is configured to control the energy density of the beam of electromagnetic radiation at the surface level by changing a power of the beam of electromagnetic radiation at the surface level, and wherein during the step of controlling, the control device changes the power of the beam of electromagnetic radiation at the surface level.

28. The method according to claim 26, wherein the control device is configured to maintain the energy density at the surface level constant along the surface level and wherein, during the step of controlling, the control device maintains the energy density at the surface level constant along the surface level.

29. The method according to claim 26, wherein:
the control device is configured to control the energy density of the electromagnetic radiation in a volume of the bath of powdered material, by controlling the dimension of the beam of electromagnetic radiation, according to the position of the beam of electromagnetic radiation at the surface level such that at the constant output power of the beam of electromagnetic radiation the energy density in the volume of the bath of powdered material of the electromagnetic radiation is maintained substantially constant along the surface level;
the energy density at any position in the volume is larger than zero; and
during the step of controlling the control device is controlling the energy density of the electromagnetic radiation in the volume of the bath of powdered material, by controlling the dimension of the beam of electromagnetic radiation, according to the position of the beam of electromagnetic radiation at the surface level such that at the constant output power of the beam of electromagnetic radiation the energy density in the volume of the bath of powdered material of the electromagnetic radiation is maintained substantially constant along the surface level.

30. The method according to claim 29, wherein the control device is configured to control the energy density of the beam of electromagnetic radiation in the volume of the bath of powdered material by controlling at least one of:
a thickness of the layer of the powdered material; and
a speed of moving the beam of electromagnetic radiation along the surface level;
and wherein during the step of controlling, the control device is controlling the energy density of the beam of electromagnetic radiation in the volume of the bath of powdered material by controlling at least one of:
the thickness of the layer of the powdered material; and
the speed of moving the beam of electromagnetic radiation along the surface level.

31. The method according to claim 26, wherein the control device is configured to control the dimension of the beam of electromagnetic radiation at the surface level by controlling at least one of:
a focus setting of the beam of electromagnetic radiation;
a beam shape of the beam of electromagnetic radiation; and
an expansion of the beam of electromagnetic radiation; and
wherein during the step of controlling the control device controls the dimension of the beam of electromagnetic radiation at the surface level by controlling at least one of:
the focus setting of the beam of electromagnetic radiation;
the beam shape of the beam of electromagnetic radiation; and
the expansion of the beam of electromagnetic radiation.

32. The method according to claim 26, wherein the control device is configured to control the power of the beam of electromagnetic radiation at the surface level by controlling at least one of:
a duty cycle of the solidifying device; and
an output power of the solidifying device; and
wherein during the step of controlling the control device controls the power of the beam of electromagnetic radiation at the surface level by controlling at least one of:
the duty cycle of the solidifying device; and
the output power of the solidifying device.

33. The method according to claim 26, wherein the control device is configured to control a hatch distance at the surface level of the beam of electromagnetic radiation according to the dimension of the beam of electromagnetic radiation, and wherein the control device controls the hatch distance at the surface level of the beam of electromagnetic radiation according to the dimension of the beam of electromagnetic radiation.
